(19) United States
(12) Patent Application Publication
(10) Pub. No.: US 2014/0271962 A1
(43) Pub. Date: Sep. 18, 2014

(54) TRIPLE PARISON COEXTRUSION MULTI-LAYER FLOWHEAD APPARATUS

(71) Applicant: Graham Packaging Company, L.P., York, PA (US)

(72) Inventor: Robert Grzegorz Rogaczewski, Goszcz (PL)

(73) Assignee: Graham Packaging Company, L.P., York, PA (US)

(21) Appl. No.: 14/164,353

(22) Filed: Jan. 27, 2014

Related U.S. Application Data
(60) Provisional application No. 61/790,197, filed on Mar. 15, 2013.

(51) Int. Cl. B29C 47/26; B29B 11/10

(52) U.S. Cl. CPC B29C 47/265; B29B 11/10
USPC 425/133.1

(57) ABSTRACT

A triple parison flowhead apparatus for producing three multi-layer parisons simultaneously. The triple parison flowhead includes a first parison flowhead, a second parison flowhead, and a third parison flowhead substantially abutted to one another. Each flowhead includes a plurality of rings having flow passages, defining a center axis, and having an annular flow conduit in fluid communication with the flow passages and a plurality of ports. A set of mold plattens having a width is located adjacent to the first, second, and third parison flowheads. The flow passages in each ring are defined by a height and a diameter of each ring, and a combination of the width of the mold plattens and the flow passages minimizes the center-to-center distances between the three parison flowheads.

### RELATED APPLICATION

This application claims the benefit of priority to U.S. Provisional Patent Application Ser. No. 61/790,197, filed on Mar. 15, 2013, the contents of which are incorporated in this application by reference.

### TECHNICAL FIELD

The present invention relates generally to a flowhead apparatus for producing bottles and like objects and, more particularly, to a triple parison, coextrusion, multi-layer flowhead apparatus.

### BACKGROUND OF THE INVENTION

Containers holding liquids and bulk solids are economically manufactured in a continuous blow molding process where a parison comprising a hollow tube of molten polymer resin is extruded continuously from a flowhead. The parison is engaged by a series of moving molds, for example, formed of mold halves which sequentially contact a respective portion of the parison by closing about the parison from opposite sides. As the mold halves close about a parison portion, knives on the mold halves may sever the parison portion from the continuously extruding parison. After a parison portion is engaged by a mold and cut from the parison, air is injected into the parison portion forcing it to expand and assume the shape of the mold, for example, the form of a bottle or like object. The mold is then opened to release the newly molded container. The newly formed container may be transported, for example, via a conveyor for further downstream processing. The mold then returns to the flowhead to mold the next container. One type of suitable apparatus for producing containers is provided in U.S. Pat. No. 5,840,349, incorporated by reference in this document in its entirety for all purposes.

It is advantageous to provide containers formed of multiple layers of different plastic resins having different characteristics. For example, a container holding food stuffs may have an innermost layer which is inert and will not react chemically with the container contents, an intermediate layer which is impermeable to oxygen to prevent the contents from oxidizing, for example, and an outermost layer which has a particular color, is resistant to abrasion, or the like.

To produce such a multi-layer container, the parison from which the container is molded is coextruded with multiple layers. This may be accomplished in the flowhead having an annular space with multiple ports for receiving different polymer resins. The different polymer resins may be forced under pressure through the ports and into the flowhead. In the three-layer example described above, the resin that will form the innermost layer enters at a point farthest upstream and conforms to the annular space to form a tube. This resin tube continues to flow through the flowhead, and the intermediate resin enters the annular space through a port positioned further downstream. The intermediate layer is forced into the annular space and forms a second tube surrounding the aforementioned tube (the annular space is larger to accommodate the second layer). Finally, the resin that will form the outermost layer is introduced to the annular space through a third port downstream from the second port, and forms a third tube surrounding the first two tubes. The three-layer parison thus formed exits the flowhead continuously, and portions of the parison are captured by the molds in a continuous process as described above to produce the containers.

Traditional flowhead design has only provided for use of a single flowhead or a dual flowhead configuration due to restrictions on the geometries of the molds based on the size and shape of the container to be molded and the flowhead itself. Thus, only a single parison or two parisons may be produced simultaneously on a given machine. Due to a limited amount of space on the molds and the flow rates of the resin materials through the flowhead, most dual parison machines have a center-to-center distance of greater than 90 mm, for example, on the order of about 100 mm or about 125 mm depending on the bottle size and machine configuration. In addition, the flow rate of the resin material is critical because a high residence time in a given portion of the flowhead can degrade and damage the resin material.

There remains a need, therefore, for an apparatus which is able to produce more than two parisons at suitable flow rates in a single apparatus while able to accommodate the confined space limitations for the molds and the flowhead.

### SUMMARY OF THE INVENTION

To meet this and other needs, and in view of its purposes, the present invention provides for a space-saving, triple parison flowhead apparatus that is able to simultaneously coextrude three multi-layer parisons. In particular, a plurality of rings having a certain size and shape are selected to provide optimal flow rates for each of the layers in the multi-layer parison. The center-to-center distance between the three parison flowheads is reduced to a small value, less than the traditional center-to-center distance of greater than 90 mm, allowing for three flowheads to be used within the confines and geometry of the mold apparatus but at the necessary flow rates to produce multi-layer parisons (e.g., six-layer parisons).

In one embodiment, the present invention provides a triple parison flowhead apparatus for producing three multi-layer parisons simultaneously. The triple parison flowhead apparatus includes a first parison flowhead, a second parison flowhead, and a third parison flowhead. The first parison flowhead includes a first plurality of rings having first flow passages, defining a first center axis, and having a first annular flow conduit in fluid communication with the first flow passages and a first plurality of ports. The second parison flowhead substantially abuts the first parison flowhead and includes a second plurality of rings having second flow passages, defining a second center axis, and having a second annular flow conduit in fluid communication with the second flow passages and a second plurality of ports. The third parison flowhead substantially abuts the second parison flowhead and includes a third plurality of rings having third flow passages, defining a third center axis, and having a third annular flow conduit in fluid communication with the third flow passages and a third plurality of ports. A first center-to-center distance is defined between the first center axis and the second center axis and a second center-to-center distance is defined between the second center axis and the third center axis.

The triple parison flowhead apparatus further includes at least one set of mold plattens. The mold plattens have a width and are located adjacent to the first, second, and third parison flowheads (e.g., the mold plattens are located beneath or above the outputs for the three parison flowheads depending on the orientation of the three parison flowheads). The triple parison flowhead apparatus is able to continuously extrude three parisons between three open mold plattens.

The first, second, and third flow passages in each ring of the first, second, and third plurality of rings are defined by a height and a diameter of each ring. It has been found that a combination of the width of the mold plattens and the geometries of the first, second, and third flow passages minimizes the first center-to-center distance and the second center-to-center distance. In particular, the first and/or second center-to-center distances are preferably less than about 85 mm, more preferably about 82.5 mm. The first center-to-center distance may equal the second center-to-center distance.

The first, second, and third plurality of rings may each comprise at least six rings. The height of the rings, which influences the flow rate of the resin materials, is preferably less than about 60 mm (about 2″) in height, more preferably about 25 mm (about 1″) in height. Each ring may correspond to one layer in the multi-layer parison. Accordingly, six rings may provide for at least six layers of material in the multi-layer parisons. The six layers may include a first virgin layer, a regrind layer, a first adhesive layer, a barrier layer, a second adhesive layer, and a second virgin layer, for example. The size and shape of the first, second, and third flow passages may be determined based on the thickness of the layers, for example, in order to provide certain flow rates. The first, second, and third plurality of ports may receive molten material from a plurality of upstream extruders.

According to another embodiment, the present invention provides a triple parison flowhead apparatus for producing three multi-layer parisons simultaneously in adjacent mold plattens. The triple parison flowhead includes first, second, and third parison flowheads. The first parison flowhead includes the first plurality of rings defining the first center axis and having the first annular flow conduit in fluid communication with the first plurality of ports. The second parison flowhead includes the second plurality of rings defining the second center axis and having the second annular flow conduit in fluid communication with the second plurality of ports. The third parison flowhead includes the third plurality of rings defining the third center axis and having the third annular flow conduit in fluid communication with the third plurality of ports. The first center-to-center distance between the first center axis and the second center axis and the second center-to-center distance between the second center axis and the third center axis may equal less than about 85 mm.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 shows a triple parison flowhead apparatus according to one embodiment of the present invention;

FIG. 2 depicts the triple parison flowhead apparatus shown in FIG. 1 and the three parisons produced in the molds beneath;

FIG. 3 provides a close-up view of six ports suitable for use with the triple parison flowhead apparatus to produce a six-layer parison;

FIG. 4 provides a cross-sectional view of the six flow passages provided by the rings in the triple parison flowhead apparatus;

FIG. 5A provides a perspective cross-sectional view of one ring suitable for use with the triple parison flowhead apparatus;

FIG. 5B provides a perspective view of the ring shown in FIG. 5A; and

FIG. 6 is a perspective view of the triple parison flowhead apparatus and associated hydraulic or pneumatic equipment suitable for operating the triple parison flowhead apparatus.

### DETAILED DESCRIPTION OF THE INVENTION

The present invention provides for a triple parison “coex” or coextrusion flowhead apparatus for producing three multi-layer parisons with a small center-to-center distance, less than the traditional center-to-center distance of greater than 90 mm, between the three parison flowheads. By selecting a stack of rings with each ring having a designed size and shape for optimal flow rates, three multi-layer parisons may be coextruded simultaneously yet still is suitable for use within the confines and geometry of the molding apparatus.

Referring now to the drawing, in which like reference numbers refer to like elements throughout the various figures that comprise the drawing, the present invention provides a triple parison flowhead apparatus 1 for producing three multi-layer parisons 140, 240, 340, simultaneously. Referring to FIG. 1, the triple parison flowhead apparatus 1 includes a first parison flowhead 100, a second parison flowhead 200, and a third parison flowhead 300.

As shown in FIG. 1, the first parison flowhead 100 includes a first plurality of rings 110. For example, the first parison flowhead 100 includes a stack of six rings 110a, 110b, 110c, 110d, 110e, and 110f. Similarly, the second parison flowhead 200 includes a second plurality of rings 210. For example, the second parison flowhead 200 includes a stack of six rings 210a, 210b, 210c, 210d, 210e, and 210f. Likewise, the third parison flowhead 300 includes a third plurality of rings 310. For example, the third parison flowhead 300 includes a stack of six rings 310a, 310b, 310c, 310d, 310e, and 310f.

A generic ring 10 is provided in FIGS. 5A and 5B to signify all of the rings 110a, 110b, 110c, 110d, 110e, 110f, 210a, 210b, 210c, 210d, 210e, 210f, 310a, 310b, 310c, 310d, 310e, and 310f described in this document. The rings 10 may be approximately cylindrical in shape with a hollow center, for example. Although ring stacks of six rings 10 are exemplified in this document, the first, second, and third parison flowheads 100, 200, and 300 may each include any suitable number of rings 10 to provide the desired number of layers in the multi-layer parisons 140, 240, and 340, for example, ranging from three to seven layers. The number of rings 10, however, may be restricted by the vertical space available to the first, second, and third parison flowheads 100, 200, and 300.

The first, second, and third parison flowheads 100, 200, and 300 each have an annular flow conduit 122, 222, and 322, respectively. The annular flow conduits 122, 222, and 322 are each defined by a tube or mandrel 130, 230, and 330, respectively. The mandrels 130, 230, and 330 may be of varying width to accommodate the numerous layers of resin material which make up the multi-layer parisons 140, 240, and 340. In other words, the diameters of the mandrels 130, 230, and 330 may increase as the resin material is added to previous layers. The mandrels 130, 230, and 330 may be supported by pin rods, 128, 228, and 328, respectively, which extend through the center of the mandrels 130, 230, and 330.

As shown in FIG. 1, the first parison flowhead 100 including the first plurality of rings 110 and the first annular flow conduit 122 define a first center axis 120 substantially centrally located within the outer diameter of the first parison flowhead 100. Similarly, the second parison flowhead 200 including the second plurality of rings 210 and the second annular flow conduit 222 define a second center axis 220 substantially centrally located within the outer diameter of the second parison flowhead 200. Likewise, the third parison flowhead 300 including the third plurality of rings 310 and the third annular flow conduit 322 define a third center axis 320 substantially centrally located within the outer diameter of the third parison flowhead 300.

As is evident in FIG. 1, the second parison flowhead 200 substantially abuts the first parison flowhead 100 and the third parison flowhead 300 substantially abuts the second parison flowhead 200. Preferably, the first, second, and third parison flowheads 100, 200, and 300 are in direct contact in order to provide for a minimum center-to-center distance between the three flowheads 100, 200, and 300. In particular, a first center-to-center distance C1 may be defined between the first center axis 120 and the second center axis 220. Similarly, a second center-to-center distance C2 may be defined between the second center axis 220 and the third center axis 320.

Referring now to FIG. 2, the first, second, and third parison flowheads 100, 200, and 300 each include a first, second, and third plurality of ports 114, 214, and 314, respectively, which provide resin materials to the first, second, and third parison flowheads 100, 200, and 300. In particular, the first parison flowhead 100 includes the first plurality of ports 114. For example, FIG. 2 shows an example with seven ports 114a, 114b, 114c, 114d, 114e, 114f, and 114g. Similarly, the second parison flowhead 200 includes the second plurality of ports 214, for example, with seven ports 214a, 214b, 214c, 214d, 214e, 214f, and 214g. Likewise, the third parison flowhead 300 includes the third plurality of ports 314. For example, the third parison flowhead 300 includes seven ports 314a, 314b, 314c, 314d, 314e, 314f, and 314g.

Referring now to FIG. 3, an example of six ports for each of the first, second, and third parison flowheads 100, 200, and 300 is shown: a first port 114a, 214a, or 314a; a second port 114b, 214b, or 314b; a third port 114c, 214c, or 314c; a fourth port 114d, 214d, or 314d; a fifth port 114e, 214e, or 314e; and a sixth port 114f, 214f, or 314f. Although six or seven ports are exemplified in this document, the first, second, and third parison flowheads 100, 200, and 300 may have any suitable number of ports 114, 214, or 314 that correspond at least to the number of rings 10 provided. Thus, the number of first, second, and third plurality of ports 114, 214, and 314 correspond to at least the selected number of rings to provide the desired number of layers in the multi-layer parisons 140, 240, and 340; for example, three to seven ports may be provided for three to seven layers. In FIG. 1, seven ports 114, 214, or 314 are provided for six rings 10.

In the case of first parison flowhead 100, each of these ports 114a, 114b, 114c, 114d, 114e, and 114f provides resin material from one or more upstream extruders (not shown) and associated equipment to transport the resin materials (e.g., melt pipes and the like). The ports 214 and 314 in the second and third parison flowheads 200 and 300 can be supplied similarly. The extruders may be, for example, screw extruders that are commonly used for extruding molten polymer resin in the art.

As best understood from FIGS. 3 and 4, the first annular flow conduit 122 is in fluid communication with the first plurality of ports 114 through a first plurality of flow passages 112. In particular, these ports 114a, 114b, 114c, 114d, 114e, and 114f are in fluid communication with the annular flow conduit 122 through the first flow passages 112a, 112b, 112c, 112d, 112e, and 112f (labeled in FIG. 4). These first flow passages 112a, 112b, 112c, 112d, 112e, and 112f are defined by the size and shape or geometry of each of the rings 110a, 110b, 110c, 110d, 110e, and 110f shown in FIG. 1 and FIGS. 5A and 5B. Similarly, the second and third parison flowheads 200 and 300 include the second plurality of flow passages 212 shown as second flow passages 212a, 212b, 212c, 212d, 212e, and 212f and the third plurality of flow passages 312 shown as third flow passages 312a, 312b, 312c, 312d, 312e, and 312f, which are substantially identical to the plurality of first flow passages 112a, 112b, 112c, 112d, 112e, and 112f. The first, second, and third plurality of ports 114, 214, and 314 should be positioned above each respective ring 10 in order to provide fluid communication to each of the respective first, second, and third flow passages 112, 212, and 312.

Thus, the first, second, and third plurality of ports 114, 214, 314 supply the first, second, and third flow passages 112, 212, and 312 with the resin materials, respectively, and the resin materials then form tubes within the first, second, and third annular flow conduits 122, 222, and 322, respectively. In particular, different polymer resins are forced under pressure through the first, second, and third plurality of ports 114, 214, 314 and into the first, second, and third flowheads 100, 200, and 300, respectively. As shown in FIG. 2, the multi-layer parisons 140, 240, and 340 comprise a plurality of resin layers 142, 242, and 342, respectively. The first multi-layer parison 140 exits the first parison flowhead 100 through an opening or outlet 126 in a first die ring 124. The second multi-layer parison 240 exits the second parison flowhead 200 through an opening or outlet 226 in a second die ring 224. The third multi-layer parison 340 exits the third parison flowhead 300 through an opening or outlet 326 in a third die ring 324.

With reference to FIG. 3, an example of a six-layer first multi-layer parison 140 and the resin layer 142 produced in the first parison flowhead 100 is described. The resin that will form the innermost layer enters at a point farthest upstream (port 114a) and conforms to the annular flow conduit 122 to form a first tube. This resin tube continues to flow through the first parison flowhead 100, and the next resin enters the annular flow conduit 122 through port 114b positioned further downstream. The intermediate layer is forced into the annular flow conduit 122 and forms a second tube surrounding the first tube. The first and second resin tubes continue to flow through the first parison flowhead 100, and the next resin enters the annular flow conduit 122 through port 114c positioned further downstream. The intermediate layer is forced into the annular flow conduit 122 and forms a third tube surrounding the second tube. The first, second, and third resin tubes continue to flow through the first parison flowhead 100, and the next resin enters the annular flow conduit 122 through port 114d positioned further downstream. The intermediate layer is forced into the annular flow conduit 122 and forms a fourth tube surrounding the third tube. The first, second, third, and fourth resin tubes continue to flow through the first parison flowhead 100, and the next resin enters the annular flow conduit 122 through port 114e positioned further downstream. The intermediate layer is forced into the annular flow conduit 122 and forms a fifth tube surrounding the fourth tube. Finally, the resin that will form the outermost layer is introduced to the annular flow conduit 122 through the sixth port 114f downstream from the fifth port 114e, and forms the sixth tube surrounding all of the previous tubes. The six-layer first parison 140 thus formed exits the first parison flowhead 100 continuously, and portions of the parison 140 are captured by the mold plattens 50 in a continuous process. It will be appreciated that the process and result are the same for the second and third parison flowheads 200 and 300.

Polymer resins useful in the layers include, but are not limited to, polyesters, polyamides, and polycarbonates. Suitable polyesters include homopolymers, copolymers or blends of polyethylene terephthalate (PET), polybutylene terephthalate (PBT), polypropylene terephthalate (PPT), polyethylene napthalate (PEN), and a cyclohexane dimethanol/PET copolymer, known as PETG. Suitable polyamides (PA) include PA6, PA6,6, PA6,4, PA6,10, PA11, PA12, etc. Other useful thermoplastic polymers include acrylic/imide, amorphous nylon, polyacrylonitrile (PAN), polystyrene, crystallizable nylon (MXD-6), polyethylene (PE), polypropylene (PP), and polyvinyl chloride (PVC).

The six layers which form the plurality of resin layers 142, 242, and 342 may include from inside to outside, for example, a first virgin layer, a regrind layer, a first adhesive layer, a barrier layer, a second adhesive layer, and a second virgin layer optionally with color. In the case of seven or more layers, two or more layers may be substituted for a single layer in order to increase the flow rate of a given resin layer. For example, the regrind layer may be provided with two layers in order to provide for a thicker total regrind layer. Regrind material may be a material that has been trimmed or discarded during the manufacture of a product and has not been used by a consumer. In contrast to regrind or recycled materials, virgin material is material that has not been used previously in the formation of a package, a portion of a package, or a precursor to a package, although the material may have been subjected to a variety of processing steps. The first and second virgin layers may include polyethylene terephthalate (PET), for example. The intermediate barrier layer may include ethylene vinyl alcohol (EVOH) or polyethylene naphthalate (PEN), for example. The regrind layer may include recycled materials, such as PET, PEN, or blends or copolymers of PET and PET. The first and second adhesive layers may include polyethyleneimine (PEI), maleic anhydride modified polyethylene, or the like. The total wall thickness may range, for example, from about 0.1 mm to about 1 mm, about 0.2 mm to about 0.8 mm, or about 0.3 to about 0.6 mm, for example.

In an exemplary embodiment, as depicted in FIGS. 1 and 2, the first, second, and third plurality of rings 110, 210, and 310 may each comprise at least six rings 10 in order to provide for seven layers of material, for example, where two layers constitute the regrind layer. In order to achieve the desired flow rates for each of the layers to obtain the necessary thicknesses of each of the layers, the geometries of the rings were specially selected. In particular, the geometries of the first, second, and third flow passages 112, 212, and 312 may be determined based on the thickness of the layers in the multi-layer parisons 140, 240, and 340 and based on certain flow rates. The triple parison flowhead apparatus 1 may produce an output or total flowrate of greater than about 680 kg/hour, greater than about 700 kg/hour, greater than about 800 kg/hour, for example, about 816 kg/hour. The output may range from about 680 kg/hour to about 900 kg/hour, more preferably about 800 kg/hour to about 830 kg/hour.

As depicted in FIGS. 5A and 5B, the ring 10 has a given geometry based on a height h, a diameter d, and the contours of an outer surface 12 of the ring 10, which defines the first, second, and third flow passages 112, 212, and 312 when the rings 10 are stacked in the first, second, and third parison flowheads 100, 200, and 300, respectively. The first flow passages 112 in each ring 10 of the first plurality of rings 110 have geometries defined by height h, diameter d, and the contours of the outer surface 12 of each ring 10. Similarly, the second flow passages 212 in each ring 10 of the second plurality of rings 210 have geometries defined by height h, diameter d, and the contours of the outer surface 12 of each ring 10. Likewise, the third flow passages 312 in each ring 10 of the third plurality of rings 310 have geometries defined by height h, diameter d, and the contours of the outer surface 12 of each ring 10.

As shown in FIGS. 5A and 5B, the outer surface 12 of the ring 10 is contoured to include protrusions, recesses, undulations, or designs to provide the optimum flow rates. The height h of the rings 10 is preferably less than about 60 mm (about 2.4″), less than about 50 mm (about 2″), less than about 40 mm (about 1.6″), less than about 30 mm (about 1.2″), and more preferably about 25 mm (1″). The diameter of the rings 10 is preferably less than about 80 mm (about 3.1″), less than about 70 mm (about 2.8″), less than about 60 mm (about 2.4″), or less than about 50 (about 2″), for example.

As shown in FIG. 2, the triple parison flowhead apparatus 1 further includes at least one set of mold plattens 50. The mold plattens 50 may include any suitable blow molds known to those skilled in the art. In particular, the size and shape of the molds plattens 50 can be selected to produce any type of bottle or discrete article having any size, shape, and dimension including containers, vessels, flasks, vials, or the like known in the art. The mold plattens 50 have a width w and are located adjacent or proximate to the outlets 126, 226, and 326 of the first, second, and third parison flowheads 100, 200, and 300. Depending on the orientation of the triple parison flowhead apparatus 1, the mold plattens 50 may be positioned beneath, above, or at an angle relative to the outlets 126, 226, and 326 for the three parison flowheads 100, 200, and 300. The triple parison flowhead apparatus 1 is able to continuously coextrude three parisons 140, 240, 340 between three open mold plattens 50. The set of mold plattens 50 may be a single pair of mold plattens 50 including three separate molding chambers or may include three separate and distinct pairs of mold plattens 50 for each respective parison flowhead 100, 200, and 300. The width w of the mold plattens 50 is dictated by the bottle size and machine configuration.

A combination of the limited width w of the mold plattens 50 and the geometries of the first, second, and third flow passages 112, 212, 312 through the stacks of rings 10 minimizes the first center-to-center distance C1 and the second center-to-center distance C2 between the first, second, and third parison flowheads 100, 200 and 300. In other words, a small center-to-center distance is obtained due to the selection of specifically sized rings 10 in the flowheads 100, 200 and 300. In an exemplary embodiment, the first center-to-center distance C1 is less than about 85 mm, less than about 84 mm, less than about 83 mm, or about 82.5 mm. For example, the first center-to-center distance C1 may range from about 82 mm to about 85 mm. Similarly, the second center-to-center distance C2 is less than about 85 mm, less than about 84 mm, less than about 83 mm, or about 82.5 mm. For example, the first center-to-center distance C1 may range from about 82 mm to about 85 mm. The first center-to-center distance C1 is preferably equal to the second center-to-center distance C2.

According to another embodiment, the present invention provides the triple parison flowhead apparatus 1 for producing three multi-layer parisons 140, 240, and 340 simultaneously in adjacent mold plattens 50. The triple parison flowhead apparatus 1 includes first, second, and third parison flowheads 100, 200, and 300. The first parison flowhead 100 includes the first plurality of rings 110 defining the first center axis 120 and having the first annular flow conduit 122 in fluid communication with the first plurality of ports 114. The second parison flowhead 200 includes the second plurality of rings 210 defining the second center axis 220 and having the second annular flow conduit 222 in fluid communication with the second plurality of ports 224. The third parison flowhead 300 includes the third plurality of rings 310 defining the third center axis 320 and having the third annular flow conduit 322 in fluid communication with the third plurality of ports 314. The first center-to-center distance C 1 between the first center axis 120 and the second center axis 220 and the second center-to-center distance C2 between the second center axis 220 and the third center axis 320 may equal less than about 85 mm (e.g., ranging from about 82 to about 85 mm).

Referring now to FIG. 6, the first, second, and third parison flowheads 100, 200, and 300 may be operated by a hydraulic or pneumatic operating system. In particular, the hydraulic or pneumatic system applies pressure to the ports 114, 214, and 314 and into the flowheads 100, 200, and 300 in order to coextrude each of the layers in the parisons 140, 240, and 340, respectively. A controller (not shown) may be used to control and coordinate the operations of the various components. For example, the controller may be a microprocessor, programmable logic controller, or other electronic control systems known in the art.

Although illustrated and described above with reference to certain specific embodiments and examples, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges. It is also expressly intended that the steps of the methods of using the various devices disclosed above are not restricted to any particular order. In addition, features of one embodiment may be incorporated into another embodiment.

What is claimed is:

1. A triple parison flowhead apparatus for producing three multi-layer parisons simultaneously, the triple parison flowhead comprising:
a first parison flowhead including a first plurality of rings having first flow passages, defining a first center axis, and having a first annular flow conduit in fluid communication with the first flow passages and a first plurality of ports;
a second parison flowhead substantially abutting the first parison flowhead, the second parison flowhead including a second plurality of rings having second flow passages, defining a second center axis, and having a second annular flow conduit in fluid communication with the second flow passages and a second plurality of ports, wherein a first center-to-center distance is defined between the first center axis and the second center axis;
a third parison flowhead substantially abutting the second parison flowhead, the third parison flowhead including a third plurality of rings having third flow passages, defining a third center axis, and having a third annular flow conduit in fluid communication with the third flow passages and a third plurality of ports, wherein a second center-to-center distance is defined between the second center axis and the third center axis, and
at least one set of mold plattens having a width and being located adjacent to the first, second, and third parison flowheads,
wherein the first, second, and third flow passages in each ring of the first, second, and third plurality of rings are defined by a height and a diameter of each ring, and a combination of the width of the mold plattens and the first, second, and third flow passages minimizes the first center-to-center distance and the second center-to-center distance.

2. The apparatus of claim 1, wherein the first center-to-center distance is less than about 85 mm.

3. The apparatus of claim 1, wherein the second center-to-center distance is less than about 85 mm.

4. The apparatus of claim 1, wherein the first center-to-center distance equals the second center-to-center distance.

5. The apparatus of claim 1, wherein the first center-to-center distance is about 82.5 mm.

6. The apparatus of claim 1, wherein the second center-to-center distance is about 82.5 mm.

7. The apparatus of claim 1, wherein the first, second, and third plurality of rings each comprise at least six rings.

8. The apparatus of claim 1, wherein each of the rings are less than about 60 mm in height.

9. The apparatus of claim 1, wherein each of the rings are about 25 mm in height.

10. The apparatus of claim 1, wherein the three multi-layer parisons are each comprised of at least six layers of material.

11. The apparatus of claim 10, wherein the at least six layers of material include a first virgin layer, a regrind layer, a first adhesive layer, a barrier layer, a second adhesive layer, and a second virgin layer.

12. The apparatus of claim 10, wherein the height and diameter of the rings of the first, second, and third flow passages are determined based on the thickness of the layers.

13. The apparatus of claim 1, wherein the triple parison flowhead produces an output of about 680 to about 900 kg/hour.

14. The apparatus of claim 1, wherein the triple parison flowhead produces an output of about 800 kg/hour to about 830 kg/hour.

15. The apparatus of claim 1, wherein the first, second, and third plurality of ports receive molten material from a plurality of upstream extruders.

16. The apparatus of claim 1, wherein the triple parison flowhead continuously extrudes three parisons between three open mold plattens.

17. A triple parison flowhead apparatus for producing three multi-layer parisons simultaneously in adjacent mold plattens, the triple parison flowhead comprising:
a first parison flowhead including a first plurality of rings defining a first center axis and having a first annular flow conduit in fluid communication with a first plurality of ports;
a second parison flowhead including a second plurality of rings defining a second center axis and having a second annular flow conduit in fluid communication with a second plurality of ports; and
a third parison flowhead including a third plurality of rings defining a third center axis and having a third annular flow conduit in fluid communication with a third plurality of ports,
wherein a first center-to-center distance between the first center axis and the second center axis and a second center-to-center distance between the second center axis and the third center axis equal less than about 85 mm.

18. The apparatus of claim 17, wherein the first and second center-to-center distances are about 82.5 mm.

19. The apparatus of claim 17, wherein the triple parison flowhead continuously extrudes three parisons between three open mold plattens.

20. The apparatus of claim 17, wherein each of the three parisons includes at least a first virgin layer, a regrind layer, a first adhesive layer, a barrier layer, a second adhesive layer, and a second virgin layer.
